(19) United States
(12) Patent Application Publication
(10) Pub. No.: US 2026/0092896 A1
(43) Pub. Date: Apr. 2, 2026

(54) WATER SURFACE AND UNDERWATER DETECTION DEVICE

(71) Applicants: Wuchang University of Technology, Wuhan City (CN); Hubei Zhouhui Automotive Technology Co., Ltd., Shiyan City (CN)

(72) Inventors: Qing AN, Wuhan City (CN); Qinzhou WEI, Shiyan City (CN); Bing FU, Shiyan City (CN); Fang LI, Wuhan City (CN); Ying HE, Wuhan City (CN); Wen HU, Wuhan City (CN); Bo WANG, Wuhan City (CN)

(21) Appl. No.: 18/903,586

(22) Filed: Oct. 1, 2024

(51) Int. Cl. G01N 29/02; B63G 8/00; G01C 13/00; G01N 29/22; G01N 29/24; G01S 7/521; G01S 15/88; G02F 1/11

(52) U.S. Cl. CPC G01N 29/02; G01C 13/00; G01N 29/221; G01N 29/2418; G01S 7/521; G01S 15/88; G02F 1/113; B63G 8/001; B63G 2008/005

(57) ABSTRACT

Provided is a water surface and underwater detection device, which relates to the technical field of ocean detection. The water surface and underwater detection device includes a fixed column, an optical plate disposed above the fixed column, and a detection portion disposed below the fixed column. The fixed column is provided with an upper detection rod connected to the optical plate and a lower detection rod connected to the detection portion. The upper detection rod is connected to the optical plate through a telescopic rod, such that the optical plate is located at a horizontal plane. A detection head is disposed on a side of the detection portion close to the optical plate. This application can perform water surface detection and underwater detection by using the optical plate that moves up and down and the axially rotating detection portion.

### TECHNICAL FIELD

The present disclosure relates to the technical field of ocean detection, and in particular, to a water surface and underwater detection device.

### BACKGROUND

There are abundant mineral resources in an ocean. With the development of science and technology and the increasing depletion of onshore resources, humans are advancing towards the development of ocean resources at an unprecedented speed. The development of the ocean resources has become a hot topic of research at home and abroad.

Resource development requires multi-dimensional detection on the ocean, including climate detection and environmental detection on water, as well as underwater water body detection, biological detection, and energy detection. Corresponding detection environments are complex, and there is a high risk if personnel enter the ocean recklessly. Therefore, at present, the ocean detection is carried out mainly by remotely controlling an unmanned detector. Moreover, existing unmanned detectors mostly have different functions, and are classified into an on-water unmanned detector and an underwater unmanned detector. Vehicles used for autonomous ocean observation are mainly classified into an underwater vehicle and a water surface vehicle. An underwater glider and a wave glider are capable of performing ultra-long range detection. The underwater glider is driven by buoyancy to perform underwater detection and sampling, while the wave glider is driven by wave force to perform water surface detection and sampling.

Considering a high cost of high-sea detection and a high detection cost of a plurality of types of detectors, it is increasingly important to develop a detection structure that can simultaneously be used for on-water and underwater detection. For example, the Chinese patent CN107490367A provides an underwater carrier device and an ocean detection device, which relates to the technical field of ocean detection equipment. The underwater carrier device includes a floating body, a counterweight body, a rope, and a carrier unit. One end of the rope is fixed onto the floating body, and the other end of the rope is fixed onto the counterweight body. The carrier unit is connected to the rope. The carrier unit includes a support body, an upper floating body, and at least two first sliding bodies. Driven by waves, the carrier unit can move up and down along the rope. The underwater carrier device provided by the above invention alleviates technical problems of complex deployment and retrieval processes of an observation device, a high risk, and high labor and device costs in a method in which a prior-art detection device is used to observe different depth layers of the ocean.

However, the above-mentioned ocean detection device still has following drawbacks: Only upward and downward carrying of the detection device can be controlled, an orientation of the detection device cannot be changed, a detection angle is small, detection efficiency is low, and the detection is greatly affected by a water body.

Therefore, in order to solve the above problems, it is necessary to design a reasonable and efficient water surface and underwater detection device.

### SUMMARY

An objective of the present disclosure is to provide a water surface and underwater detection device, which can perform water surface detection and underwater detection by using an optical plate that moves up and down and an axially rotating detection portion. A detection plate rotates to change an angle of a detection head, achieving a wide detection range and high efficiency. During the detection, the optical plate is used to guide a water flow, and a positioning groove can also be used to assist in guiding the water flow, thereby reducing interference from a water body during the detection and achieving more accurate detection.

To achieve the above objective, the present disclosure is implemented by using following technical solutions:

A water surface and underwater detection device includes a fixed column, an optical plate disposed above the fixed column, and a detection portion disposed below the fixed column, where the fixed column is provided with an upper detection rod connected to the optical plate and a lower detection rod connected to the detection portion, the upper detection rod is connected to the optical plate through a telescopic rod, such that the optical plate is located at a horizontal plane, and a detection head is disposed on a side of the detection portion close to the optical plate.

As a preferred solution of the present disclosure, the optical plate is an electrically controlled liquid crystal glass plate, such that
the electrically controlled liquid crystal glass plate is transparently disposed during on-water detection; or
the electrically controlled liquid crystal glass plate is non-transparently disposed during underwater detection.

As a preferred solution of the present disclosure, a positioning groove is disposed on the side of the detection portion close to the optical plate, and at least a part of the lower detection rod is located inside the positioning groove.

As a preferred solution of the present disclosure, the positioning groove is a circular arc-shaped groove, such that the positioning groove is coaxially disposed with the fixed column, the lower detection rod is connected to an inner sidewall of the positioning groove, and the detection portion rotates around the fixed column to adjust an orientation of the detection head on the detection portion.

As a preferred solution of the present disclosure, the lower detection rod rotates around the fixed column, and the inner sidewall of the positioning groove is provided with a positioning protrusion connected to the lower detection rod.

As a preferred solution of the present disclosure, the lower detection rod includes a first rod and a second rod, and there are at least two positioning protrusions.

As a preferred solution of the present disclosure, a clamping protrusion is disposed on a side of the optical plate close to the telescopic rod.

As a preferred solution of the present disclosure, the detection portion is provided with a processor electrically connected to the detection head and a signal transmitter electrically connected to the processor.

As a preferred solution of the present disclosure, a sonar receiver is provided on a side of the detection portion away from the optical plate.

The water surface and underwater detection device in the present disclosure has following beneficial effects:

Water surface detection and underwater detection can be performed by using the optical plate that moves up and down and the axially rotating detection portion. A detection plate rotates to change an angle of the detection head, achieving a wide detection range and high efficiency. During the detection, the optical plate is used to guide a water flow, and the positioning groove can also be used to assist in guiding the water flow, thereby reducing interference from a water body during the detection and achieving more accurate detection.

### BRIEF DESCRIPTION OF THE DRAWINGS

To describe the technical solutions in the embodiments of the present disclosure more clearly, the accompanying drawings required for describing the embodiments are briefly described below. Apparently, the accompanying drawings in the following description show merely some embodiments of the present disclosure, and those of ordinary skill in the art may still derive other accompanying drawings from these accompanying drawings without creative efforts.

FIG. 1 is an overall schematic structural diagram of a water surface and underwater detection device according to an embodiment of the present disclosure; and

FIG. 2 is an overall schematic structural diagram of a water surface and underwater detection device according to another embodiment of the present disclosure.

### DETAILED DESCRIPTION OF THE EMBODIMENTS

The following describes the technical solutions in the embodiments of the present disclosure clearly and completely with reference to the accompanying drawings in the embodiments of the present disclosure.

In the following description, terms such as “first” and “second” are merely intended for the purpose of description, and should not be construed as indicating or implying relative importance. The following description provides a plurality of embodiments of the present disclosure, and different embodiments can be replaced or combined. Therefore, the present disclosure can also be considered to include all possible combinations of the same and/or different embodiments described. Therefore, if one embodiment includes features A, B, and C, and another embodiment includes features B and D, the present disclosure should also be considered to include embodiments containing one or more other possible combinations of A, B, C, and D, although such embodiments may not be explicitly described in the following content.

The following description provides examples and does not limit the scope, applicability, or example set forth in the claims. Changes can be made to a function and an arrangement of a described element without departing from the scope of the present disclosure. In various examples, various processes or components may be omitted, replaced, or added appropriately. For example, the described method can be executed in an order different from the described order, and various steps can be added, omitted, or combined. In addition, features described about some examples can be combined into other examples.

### Embodiment 1

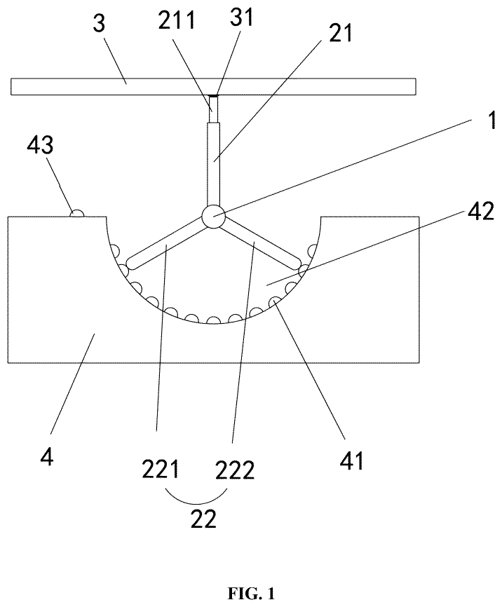

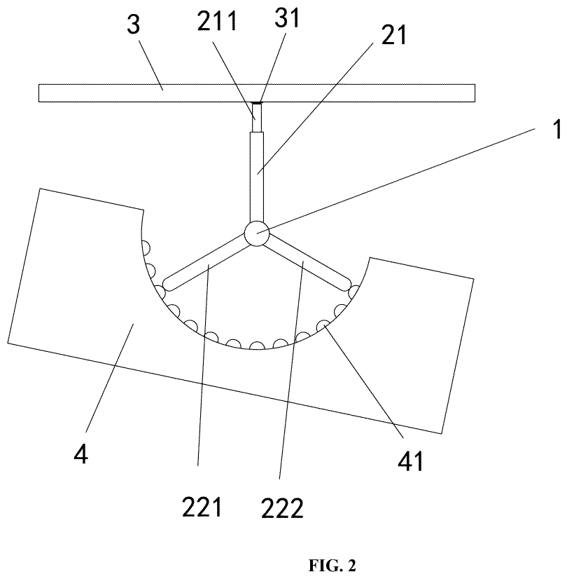

Referring to FIG. 1 and FIG. 2, a water surface and underwater detection device in the present disclosure includes a fixed column 1, an optical plate 3 disposed above the fixed column 1, and a detection portion 4 disposed below the fixed column 1. The fixed column 1 is provided with an upper detection rod 21 connected to the optical plate 3 and a lower detection rod 22 connected to the detection portion 4. The upper detection rod 21 is connected to the optical plate 3 through a telescopic rod 211, such that the optical plate 3 is located at a horizontal plane. A detection head 43 is disposed on a side of the detection portion 4 close to the optical plate 3.

In the present disclosure, the fixed column 1 is connected onto a vehicle and horizontally disposed. The fixed column 1 is a cylindrical member, and the optical plate 3 is connected to the fixed column 1 through the upper detection rod 21. The detection portion 4 is connected to the fixed column 1 through the lower detection rod 22. During deployment, both an upper surface of the detection portion 4 and the optical plate 3 are horizontally disposed.

Firstly, the optical plate 3 is disposed above the fixed column 1. The upper detection rod 21 is connected to the optical plate 3 through the telescopic rod 211, and the optical plate 3 is located at the horizontal plane through telescopic adjustment of the telescopic rod 211.

Next, the detection portion 4 is disposed below the fixed column 1, and the lower detection rod 22 protruding downward from the fixed column 1 is connected to the detection portion 4. Since the optical plate 3 is located at the horizontal plane, the detection portion 4 is disposed below a water surface. The detection head 43 is provided on the side of the detection portion 4 close to the optical plate 3, in other words, a plurality of detection heads 43 are uniformly disposed on the upper surface of the detection portion 4 for ocean detection.

Finally, switching between a water surface detection function and an underwater detection function herein depends on the optical plate 3. The optical plate 3 is an electrically controlled liquid crystal glass plate.

In this way, during on-water detection, the electrically controlled liquid crystal glass plate is transparently disposed. That is, when water surface detection is carried out, the optical plate 3 is located on the water surface, and the optical plate 3 is transparently disposed. Therefore, light on the water surface and water can pass through the optical plate 3 to reach the detection portion 4 below. The detection portion 4 receives the light to perform effective detection on the water surface to detect an on-water climate change, on-water environment data, a moving direction of an offshore on-water vessel, and the like.

In this way, during underwater detection, the electrically controlled liquid crystal glass plate is non-transparently disposed. That is, when the underwater detection is carried out, the optical plate 3 is still located on the water surface, and in this case, the optical plate 3 is non-transparently disposed. Therefore, the light on the water surface cannot pass through the optical plate 3 to interfere with the detection portion 4. Actually, in this case, the optical plate 3 reflects a ray of light returned from underwater to the detection portion 4. The detection portion 4 receives the light to perform effective underwater detection to detect a change in an underwater water body, biological data, energy data, a moving direction of a waterborne vessel, and the like.

To sum up, during the on-water detection, the optical plate 3 acts as pure transparent glass. During the underwater detection, the optical plate 3 acts as a mirror for reflection.

It should be noted that for both the on-water detection and the underwater detection, the optical plate 3 is located on the water surface, and a water body between the optical plate 3 and the detection portion 4 is constrained, and flows regularly. This can effectively reduce detection interference caused by an abnormality of the water body and achieve higher accuracy.

### Embodiment 2

Still referring to FIG. 1 and FIG. 2, on a basis of Embodiment 1, in a water surface and underwater detection device in the present disclosure, a positioning groove 42 is disposed on the side of the detection portion 4 close to the optical plate 3, and at least a part of the lower detection rod 22 is located inside the positioning groove 42.

The positioning groove 42 is a circular arc-shaped groove, such that the positioning groove 42 is coaxially disposed with the fixed column 1. The lower detection rod 22 is connected to an inner sidewall of the positioning groove 42. The detection portion 4 rotates around the fixed column 1 to adjust an orientation of the detection head 43 on the detection portion 4, so as to change an orientation angle of the detection head 43, increase a detection range, and improve detection efficiency.

Moreover, because the opening region of the positioning groove 42 is coaxially disposed with the fixed column 1, no matter how much the detection portion 4 rotates around the fixed column 1, a distance between the inner sidewall of the positioning groove 42 and the fixed column 1 is the same. In this way, the lower detection rod 22 can effectively be in contact with the inner sidewall of the positioning groove 42.

It should be noted that the positioning groove 42 is a long groove that can also be used to guide a water flow. An extension direction of the positioning groove 42 is the same as that of the fixed column 1. Therefore, the positioning groove 42 can be aligned with a direction of an ocean current only by aligning the fixed column 1 with the direction of the ocean current. The positioning groove 42 can guide the water flow. Regardless of how the detection portion 4 rotates, a region of the positioning groove 42 is still at a same axis position, without changing a direction of guiding the water flow.

### Embodiment 3

Still referring to FIG. 1 and FIG. 2, on a basis of any one of the above embodiments, in a water surface and underwater detection device in the present disclosure, the lower detection rod 22 rotates around the fixed column 1. The lower detection rod 22 includes a first rod 221 and a second rod 222. Actually, the detection portion 4 can be effectively positioned by connecting the two lower detection rods 22 to the inner sidewall of the positioning groove 42. In addition, the inner sidewall of the positioning groove 42 is provided with a positioning protrusion 41 connected to the lower detection rod 22, and there are at least two positioning protrusions 41. The two lower detection rods 22 are in contact with a plurality of positioning protrusions 41, such that a rotation angle of the detection portion 4 can be obtained.

It should be noted that a pressure sensor can be disposed at each positioning protrusion 41 to sense the lower detection rod 22. In this way, the rotation angle of the detection portion 4 is fed back constantly, and positioning assistance is also provided when the detection portion 4 returns to a horizontal setting.

In addition, a clamping protrusion 31 is disposed on a side of the optical plate 3 close to the telescopic rod 211. The optical plate 3 can be replaced at regular intervals.

Certainly, the detection portion 4 is provided with a processor electrically connected to the detection head 43 and a signal transmitter electrically connected to the processor. The detection portion 4 summarizes and processes data detected by the detection head 43, converts processed data into an electrical signal, and sends the electrical signal to onshore staff through the signal transmitter.

Finally, a sonar receiver is disposed on a side of the detection portion 4 away from the optical plate 3. The optical plate 3 can only reflect a ray of light and cannot reflect a sound wave. Therefore, the detection head on an upper side of the detection portion 4 is only an optical detection head. During the underwater detection, sonar detection is also required. The sonar receiver for receiving sonar information can be disposed on a lower side of the detection portion 4. Certainly, the sonar receiver is also electrically connected to the processor.

The water surface and underwater detection device in the present disclosure can perform the water surface detection and the underwater detection by using the optical plate that moves up and down and the axially rotating detection portion. A detection plate rotates to change an angle of the detection head, achieving a wide detection range and high efficiency. During the detection, the optical plate is used to guide the water flow, and the positioning groove can also be used to assist in guiding the water flow, thereby reducing interference from a water body during the detection and achieving more accurate detection.

Described above are merely exemplary embodiments of the present disclosure, which cannot be construed as a limitation on the scope of the present disclosure. Any equivalent changes and modifications made in accordance with the teachings of the present disclosure still fall within the scope of the present disclosure. A person skilled in the art can easily think of other implementation solutions of the present disclosure after considering the specification and practicing the disclosure herein. The present disclosure is intended to cover any variations, purposes, or adaptive changes of the present disclosure. Such variations, purposes, or adaptive changes follow the general principle of the present disclosure and include common knowledge or conventional technical means in the technical field which is not disclosed in the present disclosure. The specification and embodiments are merely considered as illustrative, and the scope and spirit of the present disclosure are defined by the claims.

What is claimed is:

1. A water surface and underwater detection device, comprising a fixed column (1), an optical plate (3) disposed above the fixed column (1), and a detection portion (4) disposed below the fixed column (1), wherein the fixed column (1) is provided with an upper detection rod (21) connected to the optical plate (3) and a lower detection rod (22) connected to the detection portion (4), the upper detection rod (21) is connected to the optical plate (3) through a telescopic rod (211), such that the optical plate (3) is located at a horizontal plane, and a detection head (43) is disposed on a side of the detection portion (4) close to the optical plate (3).

2. The water surface and underwater detection device according to claim 1, wherein the optical plate (3) is an electrically controlled liquid crystal glass plate, such that
the electrically controlled liquid crystal glass plate is transparently disposed during on-water detection; or
the electrically controlled liquid crystal glass plate is non-transparently disposed during underwater detection.

3. The water surface and underwater detection device according to claim 1, wherein a positioning groove (42) is disposed on the side of the detection portion (4) close to the optical plate (3), and at least a part of the lower detection rod (22) is located inside the positioning groove (42).

4. The water surface and underwater detection device according to claim 3, wherein the positioning groove (42) is a circular arc-shaped groove, such that the positioning groove (42) is coaxially disposed with the fixed column (1), the lower detection rod (22) is connected to an inner sidewall of the positioning groove (42), and the detection portion (4) rotates around the fixed column (1) to adjust an orientation of the detection head (43) on the detection portion (4).

5. The water surface and underwater detection device according to claim 4, wherein the lower detection rod (22) rotates around the fixed column (1), and the inner sidewall of the positioning groove (42) is provided with a positioning protrusion (41) connected to the lower detection rod (22).

6. The water surface and underwater detection device according to claim 5, wherein the lower detection rod (22) comprises a first rod (221) and a second rod (222), and there are at least two positioning protrusions (41).

7. The water surface and underwater detection device according to claim 1, wherein a clamping protrusion (31) is disposed on a side of the optical plate (3) close to the telescopic rod (211).

8. The water surface and underwater detection device according to claim 1, wherein the detection portion (4) is provided therein with a processor electrically connected to the detection head (43) and a signal transmitter electrically connected to the processor.

9. The water surface and underwater detection device according to claim 1, wherein a sonar receiver is provided on a side of the detection portion (4) away from the optical plate (3).
